(19) United States
(12) Patent Application Publication
(10) Pub. No.: US 2025/0199606 A1
(43) Pub. Date: Jun. 19, 2025

(54) Screenless Object Selection with Head Pose and Hand Gestures

(71) Applicant: Apple Inc., Cupertino, CA (US)

(72) Inventors: Bosheng Zhang, Sunnyvale, CA (US); Noah D. Bedard, Los Gatos, CA (US); Jonathan A. Topf, London (GB); Joseph A. Malia, Kingston Upon Thames (GB); Ethan T. Daniels, Los Gatos, CA (US); Brett D. Miller, San Carlos, CA (US); Kathrin Berkner Cieslicki, Los Altos, CA (US)

(21) Appl. No.: 18/985,305

(22) Filed: Dec. 18, 2024

Related U.S. Application Data
(60) Provisional application No. 63/612,082, filed on Dec. 19, 2023.

(51) Int. Cl. G06F 3/01; G06F 3/16; G06T 7/70; G06V 40/20

(52) U.S. Cl. CPC G06F 3/012; G06F 3/017; G06F 3/167; G06T 7/70; G06T 2207/30196; G06V 40/28

(57) ABSTRACT

A technique for providing user selection includes obtaining first sensor data from a first device worn on a head, and obtaining second sensor data from a second device worn on the head. The first and second sensor data are collected in a same time frame. A head position is determined for the head based on the first sensor data and the second sensor data. User input is received based on an input gesture. In response to the user input, an object in the local environment is identified based on the head position and selection input.

### BACKGROUND

Electronic devices, particularly wearable devices, allow users to interact with their environment. Extended reality (XR) devices enable immersive and interactive experiences across the spectrum of reality, from the physical to the virtual, thereby allowing a user to access virtual or digital content in a physical environment. However, some extended reality devices can be intrusive in a physical environment or difficult to wear. What is needed is an improvement to extended reality devices that allow a user to interact with a physical environment with less obstruction of the physical environment.

### BRIEF DESCRIPTIONS OF THE DRAWINGS

FIGS. 1A-1B show example diagrams of an environment in which the disclosure is practiced, in accordance with one or more embodiments.

FIG. 2A shows a flowchart of a technique for performing object detection in an environment using head pose, in accordance with some embodiments.

FIG. 2B shows a flowchart of a technique for performing object detection in an environment using image data, in accordance with some embodiments.

FIG. 3A shows a flowchart of a technique for performing object detection based on user input, in accordance with some embodiments.

FIG. 3B shows a flowchart of a technique for capturing image data based on a selection input, in accorance with some embodiments.

FIGS. 4A-4B show flow charts of example techniques for identifying a target object, in accordance with some embodiments.

FIG. 5 shows a system diagram of an electronic device which can be used for object selection, in accordance with one or more embodiments.

FIG. 6 shows an exemplary system for use in various machine vision technologies.

### DETAILED DESCRIPTION

This disclosure pertains to systems, methods, and computer readable media for enhanced user interaction without the need for display technology. In particular, embodiments described herein are directed to enabling selection and interaction of objects using head pose and hand gestures, and without the need for presentation on a display.

According to one or more embodiments, a system is provided with no screen or visual feedback. Selection and interaction with objects is enabled by determining a head direction of the user based on sensor data from the system to determine head pose. The user can use a pinch or other gesture to trigger some interaction or non-visual feedback. In some embodiments, the system may be an audio headset, such as headphones, a pair of earbuds, or the like, which include cameras capable of capturing image data of a physical environment surrounding a user.

The head position may be determined based on sensor data collected by the system. For example, sensor data may be collected at a left earbud and a right earbud. Localization may be performed at each device to determine a device position. Then, the position information for both earbuds may be combined to determine a head position. That is, the direction of a user's head can be determined based on pose information for the left earbud and the right earbud. Additionally, or alternatively, the head pose may be determined based on a stereo overlap between image data captured by a camera on one side of the user's head, and image data captured by a camera on the other side of a user's head. That is, the image data captured by the two cameras can be compared to find an overlap, which may indicate a direction that the user is directing the user's head. In addition, the overlapping image data may be used to identify an object of interest.

In some embodiments, additional audio feedback can be provided during the selection process based on the object or direction the user is determined to be looking based on head position. In doing so, the system can request confirmation or guidance for selection of a particular object. Thus, in some embodiments, a user may provide a confirmation input in the form of gesture input, audio input, or the like which can then trigger some interaction or non-visual feedback regarding the object of interest.

According to one or more embodiments, the techniques described herein provide a technical improvement by allowing gesture input without requiring a display device. Thus, the selection process can be performed in a low power mode, thereby conserving power and compute resources. Further, the techniques described herein provide a technical improvement by providing a technique for determining a direction a user is looking without performing eye tracking.

In the following description for purposes of explanation, numerous specific details are set forth in order to provide a thorough understanding of the disclosed concepts. As part of this description, some of this disclosure's drawings represent structures and devices in block diagram form, in order to avoid obscuring the novel aspects of the disclosed concepts. In the interest of clarity, not all features of an actual implementation may be described. Further, as part of this description, some of this disclosure's drawings may be provided in the form of flowcharts. The boxes in any particular flowchart may be presented in a particular order. It should be understood, however, that the particular sequence of any given flowchart is used only to exemplify one embodiment. In other embodiments, any of the various elements depicted in the flowchart may be deleted, or the illustrated sequence of operations may be performed in a different order, or even concurrently. In addition, other embodiments may include additional steps not depicted as part of the flowchart. Moreover, the language used in this disclosure has been principally selected for readability and instructional purposes and may not have been selected to delineate or circumscribe the inventive subject matter, resort to the claims being necessary to determine such inventive subject matter. Reference in this disclosure to “one embodiment” or to “an embodiment” means that a particular feature, structure or characteristic described in connection with the embodiment is included in at least one embodiment of the disclosed subject matter, and multiple references to “one embodiment” or “an embodiment” should not be understood as necessarily all referring to the same embodiment.

It will be appreciated that in the development of any actual implementation (as in any software and/or hardware development project), numerous decisions must be made to achieve a developers' specific goals (e.g., compliance with system-and business-related constraints) and that these goals may vary from one implementation to another. It will also be appreciated that such development efforts might be complex and time-consuming but would nevertheless, be a routine undertaking for those of ordinary skill in the design and implementation of graphics modeling systems having the benefit of this disclosure.

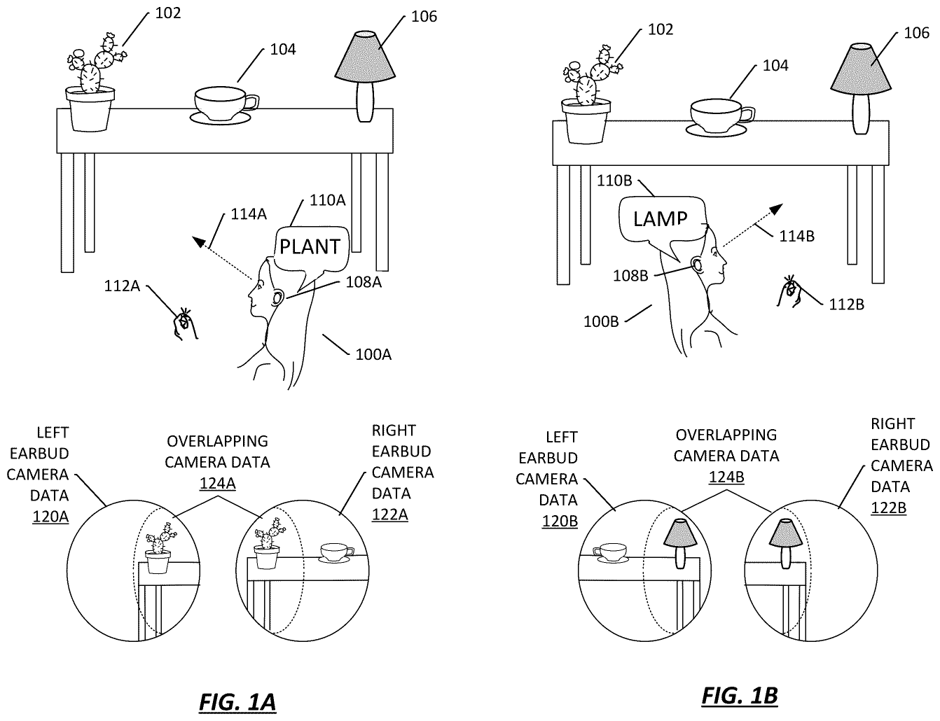

FIGS. 1A-B show example diagrams of an environment in which the disclosure is practiced, in accordance with one or more embodiments. For purposes of explanation, the various components and processes are explained in relation to particular components. However, it should be understood that the various processes and components may be performed or substituted for other processes or components as described herein. Further, it should be understood that the system setups are depicted primarily as an example to aid in the understanding of the techniques described herein.

FIG. 1A depicts an example diagram in which a user 100A is viewing a table on which three objects are placed, including a plant 102, a cup 104, and a lamp 106. The user 100A is wearing a headset, with left earbud 108A visible. The headset may be part of a head mounted system used for audio feedback. In some embodiments, the headset may include one or more cameras configured to capture image data of the physical environment surrounding the user. According to one or more embodiments, the cameras may be situated in the headset such that the field of view of each of the headsets overlap.

According to one or more embodiments, the headset may be configured to receive a user input signal. The user input signal may be received by the headset or other device communicably coupled to the headset to perform hand tracking to detect an input gesture 112A, such as a pinch, a pluck, a slide, or the like. As another example, user input may be received corresponding to a selective action, such as a mechanical button press, a vocal instruction, or the like. In some embodiments, the headset may be configured to receive the selection input signal from a secondary device, such as a mobile device or other electronic device configured to perform hand tracking. According to some embodiments, the selection input signal may trigger collection of camera data by the headset. Alternatively, the headset may obtain camera data continuously or regardless of the selection input.

In some embodiments, in response to receiving an input signal, the headset may perform object detection in image data captured by the cameras on the headset. According to one or more embodiments, the object may be detected based on a head pose. In some embodiments, the head pose may be determined based on orientation information for each earbud, or each device on each side of the head. For example, each earbud, such as left earbud 108A, may include an inertial measurement unit (IMU), and/or a camera from which visual inertial odometry (VIO) techniques can be used to determine pose information for the device, such as a position and/or orientation. The orientation data for each device can be used to determine a head pose. For example, a direction of the two devices can be used to determine a head orientation, and a midpoint between the location of each of the two devices can be determined as a head location. A vector from the midpoint in the direction of the head pose may be used to determine a view direction of the user.

Additionally, or alternatively, the camera data from each of the earbuds can be analyzed to determine an overlap in the field of view of the two cameras. Because the earbuds are worn on each side of the user's head, the overlapping field of view may be associated with a viewing direction 114A of the user. In some embodiments, the overlap in the image data can be used to determine the direction of the head pose. FIG. 1A shows left earbud camera data 120A and right earbud camera data 122A. As shown, the camera data includes overlapping camera data 124A, which captures a portion of the physical environment that is common to both the left earbud camera and the right earbud camera. As shown here, the overlapping camera data 124A includes a view of the plant 102. As a result, the earbud 108A is shown providing the audio notification 110A that says “PLANT” in response to input gesture 112A.

By contrast, the user 100B as depicted in FIG. 1B is facing a direction toward the lamp 106. This is illustrated by the viewing direction 114B of the user 100B. FIG. 1B shows left earbud camera data 120B and right earbud camera data 122B. As shown, the camera data includes an overlap 124B, which captures a portion of the physical environment that is common to both the left earbud camera and the right earbud camera. As shown here, the overlapping camera data 124B includes a view of the lamp 106. As a result, the earbud 108B is shown providing the audio notification 110B that says “LAMP” in response to input gesture 112B.

In some embodiments, in response to the selection input, such as gesture 112A, feedback is generated regarding the object of interest. The object of interest may be determined in a number of ways. For example, as shown here, the object of interest may be an object identified in the overlapping camera data 124A. Additionally, or alternatively, other input signals may be used, such as a finger pointing at a particular object. Upon detecting the object, a response will be provided, for example in the form of an audio signal. In the current example, the system provides the prompt “Plant” to identify the object as a plant in response to the selection input. However, it should be understood that the audio feedback or other action performed in response to the selection input may differ. For example, a lookup may be performed for associated data for the identified object. As another example, a user may be prompted to perform additional instructions, or the like.

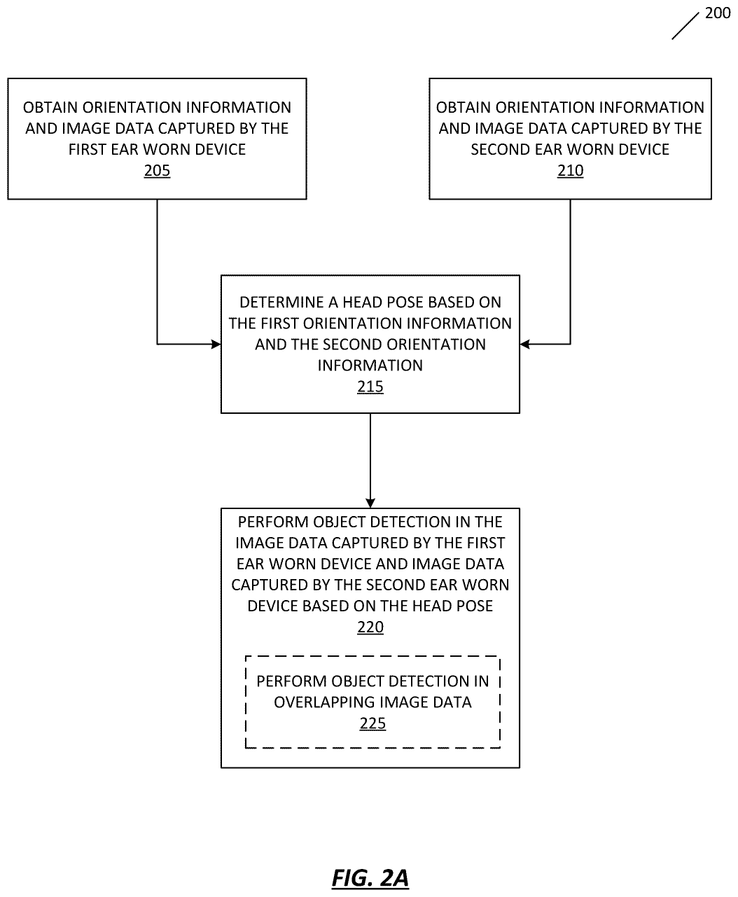

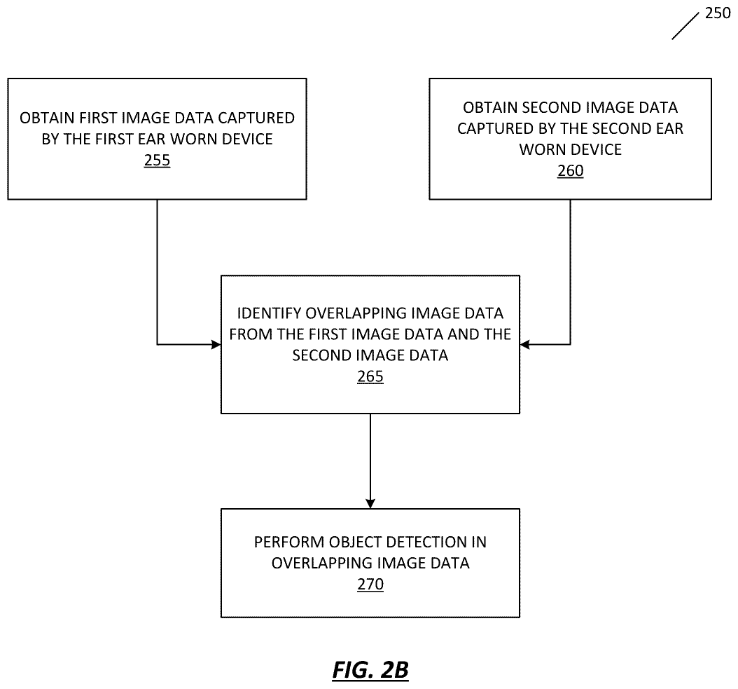

FIG. 2A shows a flowchart of a technique for performing object detection in an environment, in accordance with some embodiments. In particular, FIG. 2A describes a technique for utilizing ear-worn audio devices having image capture capability to provide feedback regarding objects in the surrounding physical environment. For purposes of explanation, the processes described below are described as being performed by particular components. However, it should be understood that the various actions may be performed by alternate components. In addition, the various actions may be performed in a different order. Further, some actions may be performed simultaneously, and some may not be required, or others may be added.

The flowchart 200 begins at block 205, where orientation information and image data are captured by a first ear worn device. For purposes of explanation, the devices described in FIG. 2A as performing the technique include a set of ear worn devices, such as an earbud pair including a left ear worn device and a right ear worn device. However, it should be understood that the device pair can take on any number of variations. For example, the left ear worn device may be a left portion of a head-worn audio system such as components on a left side of a headset, whereas the right ear worn device may be comprised of components on a right side of the same headset. Additionally, or alternatively, the ear worn devices may be in the form of in-ear devices, over-the-ear devices, on-ear devices, or the like, and may be physically coupled and/or communicably coupled.

According to one or more embodiments, the orientation information may be captured or derived from sensor data collected by one or more positional sensors, such as an inertial measurement unit (IMU), gyroscope, magnetometer, accelerometer, and/or other orientation sensor as part of the first ear worn device. The orientation information may indicate a direction the first ear worn device is oriented within a physical environment. The orientation of the first ear worn device may be determined in a number of ways. For example, visual inertial odometry (VIO) or other localization techniques may be used to determine a position and/or orientation of the first ear worn device. That is, the data from the IMU may be combined with the image data to determine position and/or orientation information for the first ear worn device. In some embodiments, the orientation information may be determined based on IMU data or other positional sensor data without the use of visual, or camera, data. Alternatively, visual odometry can be used to determine positional information without the use of other positional sensor data, in accordance with one or more embodiments.

Similarly, at block 210, orientation information is obtained from the second ear worn device. In particular, the orientation information may include a position and/or orientation of the first ear worn device. The second orientation information may be obtained at the same time, or within a same time frame, as the orientation information for the first ear worn device. The orientation information for the second ear worn device may be determined based on sensor data collected by one or more positional sensors, such as an inertial measurement unit (IMU), gyroscope, magnetometer, accelerometer, and/or other orientation sensor as part of the second ear worn device. The positional sensors may be different positional sensors than those described above to determine the orientation information for the first ear worn device. For example, the positional sensors used at block 205 may be configured to collect sensor data on a first side of a head, whereas the positional sensor data collected at block 210 may be configured to collect sensor data on a second side of the head of the user. Similarly, the image data captured by the second ear worn device may be captured by a camera configured to be situated in the vicinity of the user's second ear, as opposed to the camera used to capture image data at block 205, which may be configured to be situated in the vicinity of the user's first ear. In some embodiments, the orientation information may be determined based on the positional sensor data without the use of visual, or camera, data. Alternatively, visual odometry can be used to determine positional information without the use of other positional sensor data, in accordance with one or more embodiments.

The flowchart 200 proceeds to block 215, where a head pose is determined based on the first orientation information and the second orientation information. According to one or more embodiments, the head pose can be determined with respect to the physical environment. In some embodiments, a location of the head may be determined based on a determined location for each of the ear worn device. For example, a head pose may be determined based on a midpoint between the location information for each of the ear worn devices. Similarly, the orientation of the head may be determined based on a common orientation of the two ear worn devices, or may be based on directional information for the orientation information for each of the ear worn devices.

According to some embodiments, positional information may only be available from a single device. This may occur, for example, if a user is only wearing a single ear worn device or if one of the ear worn devices is malfunctioning. As such, an alternative technique may be used to determine head pose. As an example, orientation information may be obtained for a single ear worn device. The orientation of the head may be determined to be consistent with the device orientation, or may be determined based on the device orientation. That is, the head may be determined to be facing the same direction as the single ear worn device, or may be determined to be facing a direction that is directly related to the determined orientation of the ear worn device, such, such as a rotational offset or the like. In some additional or alternative embodiments, the head position may be determined based on an offset from a determined location of the single ear worn device. For example, a predefined offset may be used that is user-generic, or is specific to the particular user based on one or more known measurements of the user's head. The direction of the predefined offset may be determined based on a determination of a particular ear wearing the ear-worn device. For example, if the ear worn device is worn by a left year, the positional offset may be determined to the right of the ear worn device. Alternatively, if the ear worn device is worn by a right ear, the positional offset may be determined to the left of the ear worn device.

The flowchart concludes at block 220, where object detection is performed in the image data from the first ear worn device and/or image data from the second ear worn device. The object detection may be performed on one or both sets of image data. For example, at least a portion of one or both sets of image data may be determined to correspond to the head pose determined at block 215. Object detection may be performed in the image data capturing this portion of the environment. Alternatively, object detection may be performed on both sets of image data to identify objects common to both sets of image data. Object detection may include a computer vision process by which characteristics of objects captured in the image data can be analyzed to identify a classification of the object. The classification may be determined based on a predefined set of known object classes. For example, trained models can be used to ingest image data to provide predicted classifications of an object presented in the image data. In some embodiments, the object detection process may include comparing the object to a mapping of known objects to obtain information about the specific object.

Optionally, as shown at block 225, the two sets of image data may be compared to identify a stereoscopic overlap, where a same portion of an environment is captured in both sets of image data. Object detection may be performed in a subset of one or both sets of image data within the portion of image data determined to be capturing the overlapping region. In some embodiments, computer vision techniques may be performed more efficiently by discarding or otherwise not considering image data outside the overlapping portion. The overlapping portion may be combined with the determined head pose to identify a subset of the overlapping portion which is likely to align with the head pose, thereby further improving efficiency of the computer vision techniques.

In some embodiments, the view direction of the user may be inferred from the image data captured by the ear worn devices. FIG. 2B shows a flowchart of a technique for performing object detection in an environment using image data, in accordance with some embodiments. For purposes of explanation, the processes described below are described as being performed by particular components. However, it should be understood that the various actions may be performed by alternate components. In addition, the various actions may be performed in a different order. Further, some actions may be performed simultaneously, and some may not be required, or others may be added.

The flowchart 250 begins at block 255, where first image data is captured by a first ear worn device. The first image data may be captured by a front-facing or side-facing camera on an ear worn device. That is, the camera may be configured to capture image data in front of the user, and/or to the side of the user. According to some embodiments, one or both of the cameras may have a wide field of view. The camera may be a traditional RGB camera, a depth camera, or the like. Further, the camera may include a stereo or other multi camera system, a time-of-flight camera system, or the like which captures images from which information regarding the device and/or environment may be determined. According to one or more embodiments, the camera may include a wide angle lens, or ultra-wide angle lens such as a fisheye lens.

Similarly, at block 260, second image data is obtained from the second ear worn device. The second image data may be obtained at the same time, or within a same time frame, as the image data collected by the first ear worn device at block 255. The second image data may be captured by a front-facing or side-facing camera on a second ear worn device. That is, the camera may be configured to capture image data in front of the user, and/or to the side of the user. The camera may be a traditional RGB camera, a depth camera, or the like. Further, the camera may include a stereo or other multi camera system, a time-of-flight camera system, or the like which capture images from which information regarding the device and/or environment may be determined. According to one or more embodiments, the camera may include a wide angle lens, or ultra-wide angle lens such as a fisheye lens.

The flowchart continues to block 265, where the two sets of image data may be compared to identify a stereoscopic overlap, where a same portion of an environment is captured in both sets of image data. According to one or more embodiments, when the first ear worn device and second ear worn device are donned by a user and images are captured by the devices at the same time or within a same time period, an overlapping portion of the image data may be determined in each set of image data where a same portion of the physical environment is captured. For example, a right side of the image data captured by a camera associated with the left ear worn device may include image data capturing a same portion of the physical environment as a left side of the image data captured by a camera associated with the right ear worn device.

The flowchart 250 concludes at block 270, where object detection is performed in the overlapping image data. Object detection may be performed in a subset of one or both sets of image data within the portion of image data determined to be capturing the overlapping region. In some embodiments, computer vision techniques may be performed more efficiently by discarding or otherwise not considering image data outside the overlapping portion. Notably, the overlapping portion of image data may be used as a proxy for head pose, in accordance with one or more embodiments. That is, object detection is performed in the overlapping image data because an inference can be made that the head pose is facing the direction of the overlapping image data.

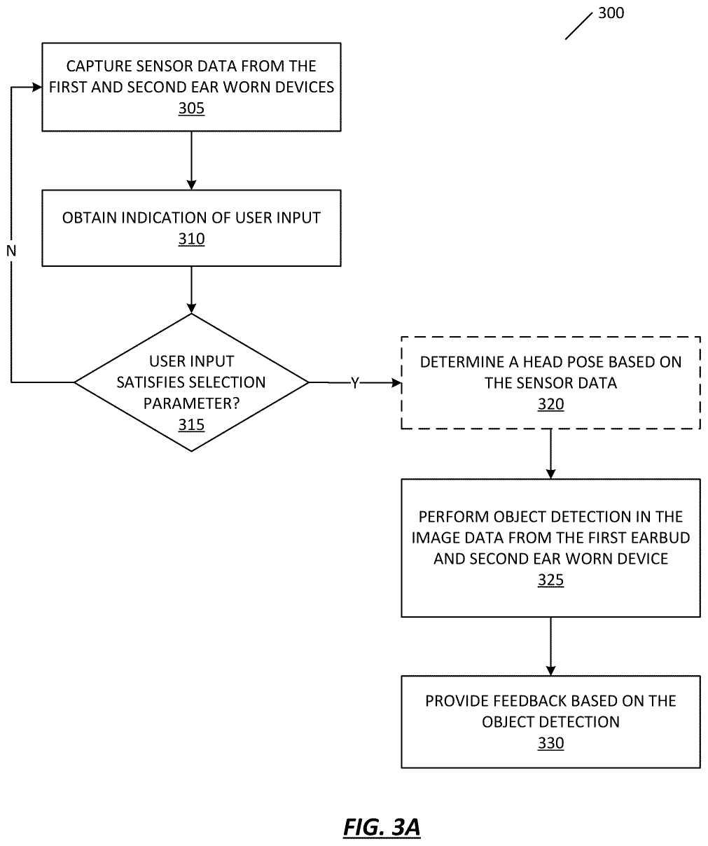

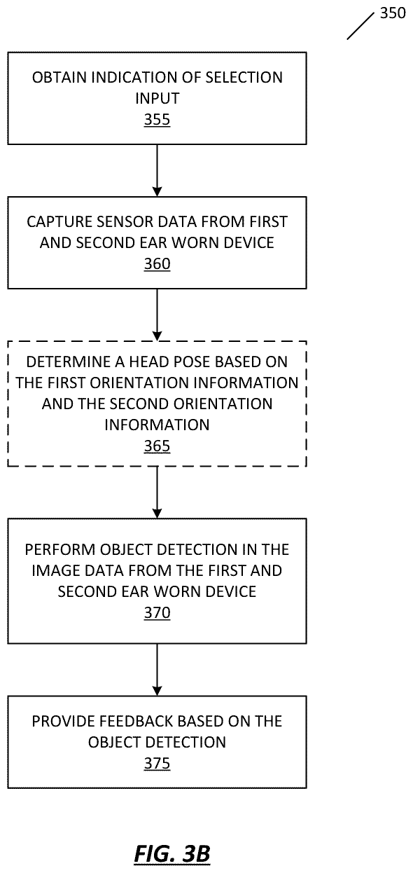

In some embodiments, input gestures can be used to further enhance object detection. FIG. 3A shows a flowchart of a technique for performing object detection based on user input, in accordance with some embodiments. In particular, FIG. 3 shows a technique for determining when to perform object detection, in accordance with one or more embodiments. For purposes of explanation, the processes described below are described as being performed by particular components. However, it should be understood that the various actions may be performed by alternate components. In addition, the various actions may be performed in a different order. Further, some actions may be performed simultaneously, and some may not be required, or others may be added.

The flowchart 300 begins at block 305, where sensor data is captured from the first and second ear worn devices. As described above, each ear worn device may include one or more positional sensors and/or cameras. The positional sensors may include one or more types of positional sensors, such as an inertial measurement unit (IMU), gyroscope, magnetometer, accelerometer, and/or other orientation sensor as part of the second ear worn device. The positional sensors may be different positional sensors than those described above to determine the orientation information for the first ear worn device. The camera may be a traditional RGB camera, a depth camera, or the like. Further, the camera may include a stereo or other multi camera system, a time-of-flight camera system, or the like which capture images from which information regarding the device and/or environment may be determined. According to one or more embodiments, the camera may include a wide angle lens, or ultra-wide angle lens such as a fisheye lens. The camera may be a front-facing or side-facing camera on a second ear worn device. That is, the camera may be configured to capture image data in front of the user, and/or to the side of the user. According to one or more embodiments, the sensor data, including the positional data and/or image data, may be captured continuously during runtime, or may be captured occasionally or periodically. As will be described in greater detail below with respect to FIG. 3B, in some embodiments, the sensor data may be captured in response to user input or another triggering event.

The flowchart 300 continues at block 310, where an indication of user input is obtained. According to one or more embodiments, the user input may be in the form of a user input gesture, or physical user input. For example, the user input may include a gesture input such as a pinch or other in-air gesture, a tap of a button on the ear worn device, a physical input on an accessory device, such as a watch or touch screen device, and/or voice commands. The indication may be obtained by detecting the user input at the device, or receiving an indication that the user input has been detected at an accessory device, such as a watch or other wearable device, a mobile device, a laptop or other computing device, or the like.

At block 315, a determination is made as to whether the user input satisfies a selection parameter. For example, if a gesture is detected, a determination may be made as to whether the gesture is a selection gesture. As another example, if the user input is a voice command, a determination may be made as to whether the voice command is a selection command. If a determination is made that the user input does not satisfy a selection parameter, then the flowchart returns to block 305, and the ear worn devices continue to capture sensor data.

Returning to block 315, if a determination is made that the user input does satisfy a selection parameter, then the flowchart continues to optional block 320. At block 320, a head pose is determined based on the head pose. According to one or more embodiments, the head pose may be determined based on image data and/or positional data captured by one or more of the ear worn devices. As described above with respect to FIG. 2A, the head pose may be based on individual positional information for each of the ear worn device, or by one of the ear worn devices. However, as described above with respect to FIG. 2B, in some embodiments object detection may be determined without determining head pose.

The flowchart 300 continues to block 325, where object detection is performed in the image data from the first and/or second ear worn device. As described above, object detection may be performed in a subset of the captured image data, where the subset corresponds to a portion of the image data where both ear worn devices capture image data of a common portion of the physical environment. In some embodiments, computer vision techniques may be performed more efficiently by discarding or otherwise not considering image data outside the overlapping portion. In some embodiments, the portion of the image data in which object detection is performed may further be determined based on head pose determined at block 320. For example, a particular portion of the image data that aligns with a head pose vector may be used for object detection.

The flowchart 300 concludes at block 330, where feedback is provided based on the object detection. In some embodiments, the feedback includes information regarding the detected object in the form of audio feedback. For example, the audio feedback may include an object description, a representative sound, and/or a modulation in the volume, pitch, or pan of the audio based on a brightness, color, and/or gradient of the object. Additionally, or alternatively, the feedback may include audio data related to the object, which may be obtained from a local device, such as the ear worn devices and/or another accessory object communicably coupled to the ear worn devices. As another example, the audio feedback may be obtained from a remote source. For example, a mapping of the environment may include network path information for known objects in the physical environment. Upon detecting the object, the audio feedback may include the audio data from the network path location. In additional or alternative embodiments, the feedback may include triggering functionality of a computing device in response to the detected user input. For example, the device may initiate execution of an application based on the user selection, either locally or at a communicably connected device.

In some embodiments, system resources may be conserved by collecting image data in response to an input action being detected. FIG. 3B shows a flowchart of a technique for capturing image data based on a selection input, in accorance with some embodiments. For purposes of explanation, the processes described below are described as being performed by particular components. However, it should be understood that the various actions may be performed by alternate components. In addition, the various actions may be performed in a different order. Further, some actions may be performed simultaneously, and some may not be required, or others may be added.

The flowchart 350 begins at block 355, where an indication of a selection input is obtained. According to one or more embodiments, the user input may be in the form of a user input gesture, or physical user input. For example, the user input may include a gesture input such as a pinch or other in-air gesture, a tap of a button on the ear worn device, a physical input on an accessory device, such as a watch or touch screen device, and/or voice commands. The indication may be obtained by detecting the user input at the device, or receiving an indication that the user input has been detected at an accessory device, such as a watch or other wearable device, a mobile device, a laptop or other computing device, or the like. In some embodiments, the selection input may be identified via non-image data, and/or based on low resolution image data.

The flowchart 350 proceeds to block 360, where sensor data is captured from the first and second ear worn devices. As described above, each ear worn device may include one or more positional sensors and/or cameras. The sensors may be the same or different than the sensors used to detect the selection input. The positional sensors may include one or more positional sensors, such as an inertial measurement unit (IMU), gyroscope, magnetometer, accelerometer, and/or other orientation sensor as part of the second ear worn device. The positional sensors may be different positional sensors than those described above to determine the orientation information for the first ear worn device. The camera may be a traditional RGB camera, a depth camera, or the like. Further, the camera may include a stereo or other multi camera system, a time-of-flight camera system, or the like which capture images from which information regarding the device and/or environment may be determined. According to one or more embodiments, the camera may include a wide angle lens, or ultra-wide angle lens such as a fisheye lens. The camera may be a front-facing or side-facing camera on a second ear worn device. That is, the camera may be configured to capture image data in front of the user, or to the side of the user.

Optionally, at block 365, a head pose is determined based on the sensor data. In particular, a head pose may be determined based on orientation information derived from the sensor data captured at block 360. According to one or more embodiments, the head pose may be determined based on image data and/or positional data captured by one or more of the ear worn devices. As described above with respect to FIG. 2A, the head pose may be based on individual positional information for each of the ear worn device, or by one of the ear worn devices. However, as described above with respect to FIG. 2B, in some embodiments object detection may be determined without determining head pose.

The flowchart 350 proceeds to block 370, where object detection is performed in the image data from the first and second ear worn device. As described above, object detection may be performed in a subset of the captured image data, where the subset corresponds to a portion of the image data where both ear worn devices capture image data of a common portion of the physical environment. In some embodiments, computer vision techniques may be performed more efficiently by discarding or otherwise not considering image data outside the overlapping portion. In some embodiments, the portion of the image data in which object detection is performed may further be determined based on head pose determined at block 320. For example, a particular portion of the image data that aligns with a head pose vector may be used for object detection.

The flowchart 350 concludes at block 375, where feedback is provided based on the object detection. In some embodiments, the audio feedback includes information regarding the detected object. For example, the feedback may include an object description, a representative sound, and/or a modulation in the volume, pitch, or pan of the audio based on a brightness, color, and/or gradient of the object. Additionally, or alternatively, the audio feedback may include audio data related to the object, which may be obtained from a local device, such as the ear worn devices and/or another accessory object communicably coupled to the ear worn devices. As another example, the audio feedback may be obtained from a remote source. For example, a mapping of the environment may include network path information for known objects in the physical environment. Upon detecting the object, the audio feedback may include the audio data from the network path location. In additional or alternative embodiments, the feedback may include triggering functionality of a computing device in response to the detected user input. For example, the device may initiate execution of an application based on the user selection, either locally or at a communicably connected device.

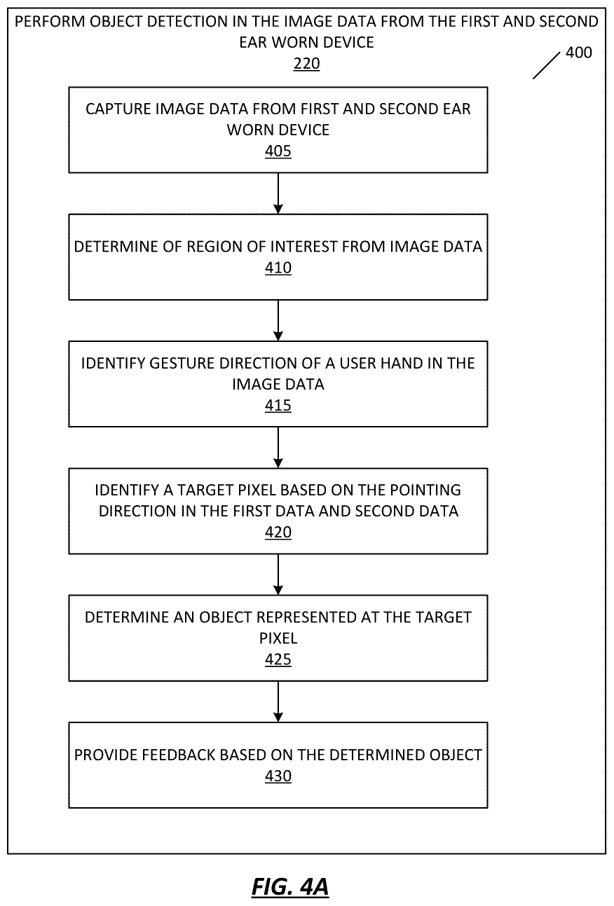

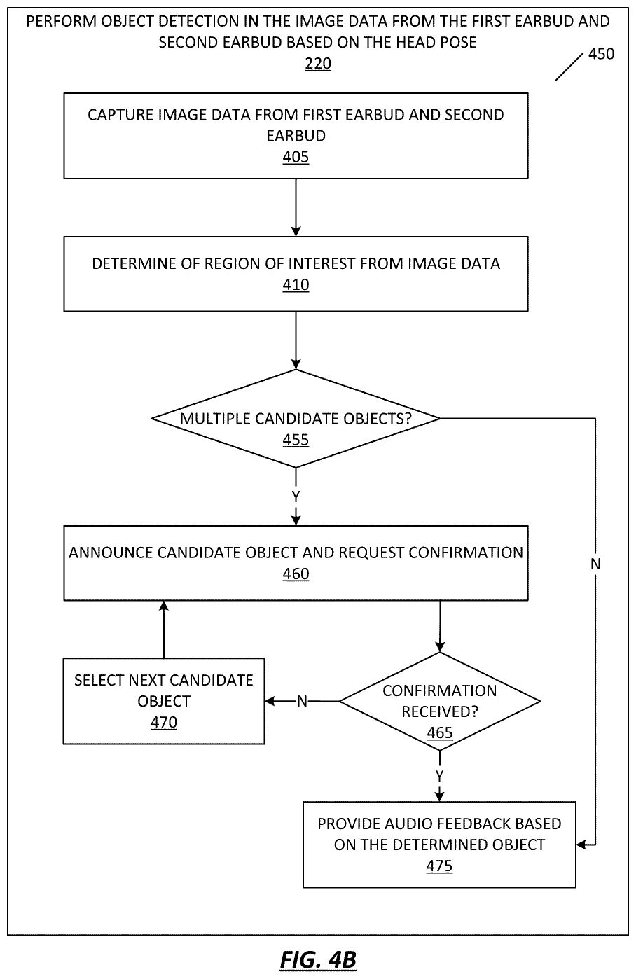

FIGS. 4A-B depict flow charts of example techniques for identifying a target object, in accordance with some embodiments. Turning to FIG. 4A, a technique is presented for using a visible gesture in the image data to perform object detection, in accordance with one or more embodiments. Specifically, the flowchart 400 of FIG. 4A shows an example technique for performing object detection, as described above with respect to block 220 of FIG. 2A. For purposes of explanation, the processes described below are described as being performed by particular components. However, it should be understood that the various actions may be performed by alternate components. In addition, the various actions may be performed in a different order. Further, some actions may be performed simultaneously, and some may not be required, or others may be added.

The flowchart 400 begins at block 405, where image data is captured by the first and second ear worn devices. According to one or more embodiments, the image data may be images captured by cameras of the ear worn devices, as described above with respect to blocks 205 and 210 of FIG. 2A, or blocks 255 and 260 of FIG. 2B. Additionally, or alternatively, the image data captured at block 405 may be additional image data. That is, the image data captured at blocks 205 and 210 of FIG. 2A may be used for determining head position, and additionally captured frames may be used at block 405 for performing object detection.

The flowchart 400 continues to block 410, where a region of interest is determined from the image data. According to one or more embodiments, a region of interest may be identified based on a stereo overlap, and/or based on a head pose. The region of interest may identify a general region in the image data in which a user is requesting feedback.

At block 415, a gesture direction is determined in the image data. The gesture may be a pointing gesture or the like. In some embodiments, the gesture may include another gesture which indicates a direction indicative of an object of interest. Then, at block 420, a target pixel is identified based on the gesture. The target pixel may be associated with a pixel or pixels in the image data at which the gesture is determined to be pointing. In some embodiments, rather than a target pixel, a target region or other location may be used.

The flowchart proceeds to block 425, where an object is determined at the target pixel. For example, a determination may be made as to an object being represented by the target pixel. In some embodiments, the pixel may be determined to belong to a particular salient object. As another example, a nearest salient object can be determined for the pixel. Object detection can be performed based on the saliency to identify the object.

The flowchart 400 concludes at block 430, where feedback is provided based on the determined object. In some embodiments, the feedback includes audio feedback including information regarding the detected object. For example, the feedback may include an object description, a representative sound, and/or a modulation in the volume, pitch, or pan of the audio based on a brightness, color, and/or gradient of the object. Additionally, or alternatively, the audio feedback may include audio data related to the object, which may be obtained from a local device, such as the ear worn devices and/or another accessory object communicably coupled to the ear worn devices. As another example, the audio feedback may be obtained from a remote source. For example, a mapping of the environment may include network path information for known objects in the physical environment. Upon detecting the object, the audio feedback may include the audio data from the network path location. In additional or alternative embodiments, the feedback may include triggering functionality of a computing device in response to the detected user input. For example, the device may initiate execution of an application based on the user selection, either locally or at a communicably connected device.

According to some embodiments, the particular object the user is looking at may not immediately be clear. FIG. 4B shows a flowchart of an example technique for performing object detection by providing preview prompts, in accordance with some embodiments. For purposes of explanation, the processes described below are described as being performed by particular components. However, it should be understood that the various actions may be performed by alternate components. In addition, the various actions may be performed in a different order. Further, some actions may be performed simultaneously, and some may not be required, or others may be added.

The flowchart 450 begins at block 405, where image data is captured by the first and second ear worn devices. According to one or more embodiments, the image data may be images captured by cameras of the ear worn devices, as described above with respect to blocks 205 and 210 of FIG. 2A, or blocks 255 and 260 of FIG. 2B. Additionally, or alternatively, the image data captured at block 405 may be additional image data. Then, at block 410, where a region of interest is determined from the image data. According to one or more embodiments, a region of interest may be identified based on a stereo overlap, and/or based on a head pose. The region of interest may identify a general region in the image data in which a user is requesting feedback.

The flowchart 450 proceeds to block 455, where a determination is made as to whether multiple candidate objects are present. Multiple candidate objects may be present, for example, if two or more potential objects are located in the environment in the viewing direction of the user based on the head pose or overlapped image data. For example, two or more salient objects may be present in the overlapping image data. As another example, two or more salient objects may be present within a region of interest. To that end, the determination of whether multiple salient objects are present may include applying the image data, or a portion of the image data corresponding to the region of interest to a trained saliency network which is configured to predict if and where salient objects are present in the image data. If at block 455 a determination is made that multiple candidate objects are not present, then the flowchart concludes at block 475, where audio feedback is provided based on the determined object. That is, the singular candidate object that is present in the region of interest is used to obtain and present audio feedback.

Returning to block 455, if a determination is made that multiple candidate objects are present, then the flowchart 450 proceeds to block 460, where a first candidate object is announced or identified to a user. In some embodiments, confirmation may be requested. The candidate object that is announced may initially be a candidate object associated with a highest confidence value among various candidate objects. For example, objects identified within the region of interest may be identified, and a network may determine, based on the head pose or other directional information, a likelihood that a particular salient object is the intended salient object for the selection.

The flowchart proceeds to block 465, where a determination is made as to whether confirmation is received. According to some embodiments, confirmation may be received in the form of predefined user input, such as audio feedback identifying the object may be provided and a user may provide some confirmation feedback, such as a pinch, tap, voice command, or the like. If a determination is made that confirmation is received, then the flowchart concludes at block 475, where audio feedback is provided based on the determined object. That is, the announced candidate object that is present in the region of interest is used to obtain and present audio feedback.

Returning to block 465, if a determination is made that the confirmation is not received, then the flowchart proceeds to block 470. Confirmation may not be received, for example, after a timeout period. Additionally, or alternatively, an affirmative negative response to the confirmation may be received, such as an alternative pinch, tap, voice command, or the like. Further, in some embodiments, an affirmative negative response may be received in the form of a change in head position such that the user moves the user's head to better point to the object of interest.

At block 470, a next candidate object is selected. According to some embodiments, the next candidate object may be selected based on a next closest salient object in the region of interest. Additionally, or alternatively, the next candidate object may be selected based on an updated head position or head movement of the user. For example, a user may shift the user's view in a particular direction such that confident values for the salient objects in that direction may increase. As such, updated confidence values may be used to identify a next salient object.

The flowchart then continues to block 460, where the next selected candidate object is then announced, and the flowchart proceeds through blocks 460, 465, and 470 until confirmation is received for a particular object. When confirmation is received at block 465, audio feedback is provided based on the determined object. That is, the most recent announced candidate object is used to obtain and present audio feedback.

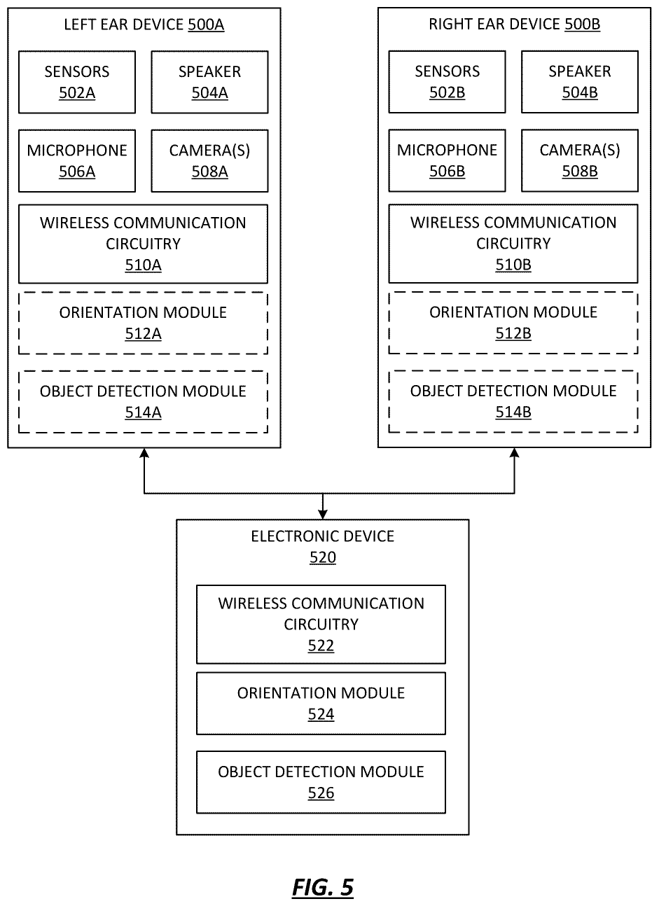

FIG. 5 shows a system diagram of an electronic device which can be used for object selection, in accordance with one or more embodiments. In particular, FIG. 5 shows an example wearable device 500 comprised of a left ear device 500A and a right ear device 500B which can be physically or communicably coupled to each other.

Each of left ear device 500A and right ear device 500B may have a wireless communications circuitry, as shown by wireless communication circuitry 510A and wireless communication circuitry 510B. The wireless communication circuitry may include one or more radio-frequency transceivers for supporting wireless communications with other devices. Further, each of left ear device 500A and right ear device 500B may have one or more sensors, shown as sensors 502A and sensors 502B. These sensors may include positional sensors, such as inertial measurement unit (IMU), gyroscope, magnetometer, accelerometer, and/or other orientation sensor as part of the first ear worn device.

Each of left ear device 500A and right ear device 500B may have additional components such as speakers, as shown by speaker 504A and speaker 504B. Each of speaker 504A and speaker 504B may be configured to play audio into the ears of a user when the left ear device 500A and/or the right ear device 500B is donned by the user. Each of left ear device 500A and right ear device 500B may have microphones, as shown by microphone 506A and microphone 506B. Each of microphone 506A and microphone 506B may be configured to gather audio data such as the voice of a user making voice commands, and/or audio signals from the surrounding physical environment.

Each of left ear device 500A and right ear device 500B may include cameras, as shown by camera(s) 508A and camera(s) 508B. Each of camera(s) 508A and camera(s) 508B may be a traditional RGB camera, a depth camera, or the like. Further, the camera may include a stereo or other multi camera system, a time-of-flight camera system, or the like which captures images from which information regarding the device and/or environment may be determined. According to one or more embodiments, the camera may include a wide angle lens, or ultra-wide angle lens such as a fisheye lens. The camera may be a front-facing or side-facing camera on a second ear worn device. That is, the camera may be configured to capture image data in front of the user, or to the side of the user.

Optionally, the left ear device 500A and/or the right ear device 500B may include an orientation module and object detection module, as shown by orientation module 512A and orientation module 512B, as well as object detection module 514A and object detection module 514B. Orientation module 512A and/or orientation module 512B may be used to determine the position and/or orientation information for each of the devices. For example, orientation module 512A may use sensor data captured by sensors 502A and/or camera(s) 508A to determine position and/or orientation information for the left ear device 500A. Similarly, orientation module 512B may use sensor data captured by sensors 502B and/or camera(s) 508B to determine position and/or orientation information for the right ear device 500B. In some embodiments, one of the left ear device 500A or right ear device 500B may be a primary device which is configured to receive the sensor data from the alternate ear device, determine positional and/or orientation information based on that sensor data, and provide the positional and/or orientation information back to the device from which the sensor data was received. Additionally, or alternatively, the sensor data from left ear device 500A and/or right ear device 500B may provide the sensor data to electronic device 520, which can then use a local orientation module 524 to determine positional and/or orientation information for the corresponding ear device.

Similarly, the left ear device 500A and/or the right ear device 500B may optionally include an object detection module and object detection module, as shown by object detection module 514A and object detection module 514B. Object detection module 514A and/or object detection module 514B may be used to detect objects in provided image data. For example, object detection module 514A may use image data captured by camera(s) 508A to identify objects in image data captured by the left ear device 500A. Similarly, object detection module 514B may use image data captured by camera(s) 508B to identify objects in image data captured by the right ear device 500B. In some embodiments, one of the left ear device 500A or right ear device 500B may be a primary device which is configured to receive the image data from the alternate ear device, perform object detection, and provide information about the object back to the device from which the sensor data was received. Additionally, or alternatively, the camera data from left ear device 500A and/or right ear device 500B may be provided to electronic device 520, which can then use a local object detection module 526 to detect objects in provided image data.

Electronic device 520 may be an accessory device or other electronic device communicably coupled to the wearable device 500, for example over a network. In some embodiments, electronic device 520 may include more compute power, memory, or the like, than left ear device 500A and/or right ear device 500B. As such, processes may be offloaded from the left ear device 500A and/or right ear device 500B to the electronic device 520. To that end, electronic device 520 may additionally include wireless communication circuitry 522, which can be used to support wireless communications with other devices, such as left ear device 500A and right ear device 500B.

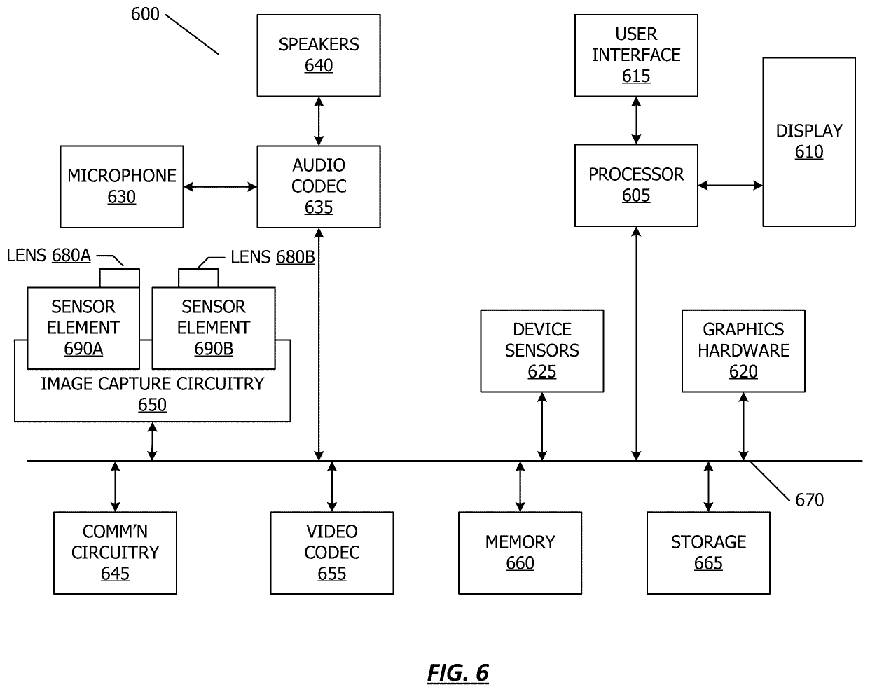

Referring now to FIG. 6, a simplified functional block diagram of illustrative multifunction electronic device 600 is shown according to one embodiment. Each electronic device may be a multifunctional electronic device, or may have some or all of the described components of a multifunctional electronic device described herein. Multifunction electronic device 600 may include some combination of processor 605, display 610, user interface 615, graphics hardware 620, device sensors 625 (e.g., proximity sensor/ambient light sensor, accelerometer and/or gyroscope), microphone 630, audio codec 635, speaker(s) 640, communications circuitry 645, digital image capture circuitry 650 (e.g., including camera system), memory 660, storage device 665, and communications bus 670. Multifunction electronic device 600 may be, for example, a mobile telephone, personal music player, wearable device, tablet computer, and the like.

Processor 605 may execute instructions necessary to carry out or control the operation of many functions performed by device 600. Processor 605 may, for instance, drive display 610 and receive user input from user interface 615. User interface 615 may allow a user to interact with device 600. For example, user interface 615 can take a variety of forms, such as a button, keypad, dial, a click wheel, keyboard, display screen, touch screen, and the like. Processor 605 may also, be a system-on-chip such as those found in mobile devices and include a dedicated graphics processing unit (GPU). Processor 605 may be based on reduced instruction-set computer (RISC) or complex instruction-set computer (CISC) architectures or any other suitable architecture and may include one or more processing cores. Graphics hardware 620 may be special purpose computational hardware for processing graphics and/or assisting processor 605 to process graphics information. In one embodiment, graphics hardware 620 may include a programmable GPU.

Image capture circuitry 650 may include one or more lens assemblies, such as 680A and 680B. The lens assemblies may have a combination of various characteristics, such as differing focal length and the like. For example, lens assembly 680A may have a short focal length relative to the focal length of lens assembly 680B. Each lens assembly may have a separate associated sensor element 690. Alternatively, two or more lens assemblies may share a common sensor element. Image capture circuitry 650 may capture still images, video images, enhanced images, and the like. Output from image capture circuitry 650 may be processed, at least in part, by video codec(s) 655 and/or processor 605 and/or graphics hardware 620, and/or a dedicated image processing unit or pipeline incorporated within circuitry 645. Images so captured may be stored in memory 660 and/or storage 665.

Memory 660 may include one or more different types of media used by processor 605 and graphics hardware 620 to perform device functions. For example, memory 660 may include memory cache, read-only memory (ROM), and/or random-access memory (RAM). Storage 665 may store media (e.g., audio, image, and video files), computer program instructions or software, preference information, device profile information, and any other suitable data. Storage 665 may include one or more non-transitory computer-readable storage mediums including, for example, magnetic disks (fixed, floppy, and removable) and tape, optical media such as CD-ROMs and digital video disks (DVDs), and semiconductor memory devices such as Electrically Programmable Read-Only Memory (EPROM), and Electrically Erasable Programmable Read-Only Memory (EEPROM). Memory 660 and storage 665 may be used to tangibly retain computer program instructions or computer readable code organized into one or more modules and written in any desired computer programming language. When executed by, for example, processor 605, such computer program code may implement one or more of the methods described herein.

It is to be understood that the above description is intended to be illustrative, and not restrictive. The material has been presented to enable any person skilled in the art to make and use the disclosed subject matter as claimed and is provided in the context of particular embodiments, variations of which will be readily apparent to those skilled in the art (e.g., some of the disclosed embodiments may be used in combination with each other). Accordingly, the specific arrangement of steps or actions shown in FIGS. 2-4 or the arrangement of elements shown in FIGS. 1 and 5-6 should not be construed as limiting the scope of the disclosed subject matter. The scope of the invention therefore should be determined with reference to the appended claims, along with the full scope of equivalents to which such claims are entitled. In the appended claims, the terms “including” and “in which” are used as the plain-English equivalents of the respective terms “comprising” and “wherein.”

1. A method comprising:
obtaining first sensor data from a first device worn on a head;
obtaining second sensor data from a second device worn on the head, wherein the first sensor data and the second sensor data correspond to a first time;
determining a head position for the head based on the first sensor data and the second sensor data; and
in response to receiving a selection input, identifying an object in a local environment based on the head position and the selection input.

2. The method of claim 1, wherein the first sensor data comprises first orientation data, and wherein the second sensor data comprises second orientation data.

3. The method of claim 1, wherein the first sensor data comprises first image data, wherein the second sensor data comprises second image data, and wherein determining the head position comprises determining a direction of the head based on an overlap between the first image data and the second image data.

4. The method of claim 3, wherein identifying the object comprises:
performing object detection on the overlap between the first image data and the second image data.

5. The method of claim 1, wherein the selection input comprises a selection gesture.

6. The method of claim 1, further comprising:
generating audio feedback regarding the object in response to identifying the object.

7. The method of claim 1, wherein the selection input is detected on an accessory device, and wherein the selection input is received from the accessory device.

8. The method of claim 1, wherein the first device comprises a first earbud of an earbud pair, and wherein the second device comprises a second earbud of the earbud pair.

9. A non-transitory computer readable medium comprising computer readable code executable by one or more processor to:
obtain first sensor data from a first device worn on a head;
obtain second sensor data from a second device worn on the head, wherein the first sensor data and the second sensor data correspond to a first time;
determine a head position for the head based on the first sensor data and the second sensor data; and
in response to receiving a selection input, identify an object in a local environment based on the head position and the selection input.

10. The non-transitory computer readable medium of claim 9, wherein the first sensor data comprises first orientation data, and wherein the second sensor data comprises second orientation data.

11. The non-transitory computer readable medium of claim 9, wherein the first sensor data comprises first image data, wherein the second sensor data comprises second image data, and wherein determining the head position comprises determining a direction of the head based on an overlap between the first image data and the second image data.

12. The non-transitory computer readable medium of claim 11, wherein the computer readable code to identify the object comprises computer readable code to:
perform object detection on the overlap between the first image data and the second image data.

13. The non-transitory computer readable medium of claim 9, wherein the selection input comprises a selection gesture.

14. The non-transitory computer readable medium of claim 9, further comprising computer readable code to:
generate audio feedback regarding the object in response to identifying the object.

15. The non-transitory computer readable medium of claim 9, wherein the computer readable code to identify an object in a local environment based on the head position and the selection input further comprises computer readable code to:
detect a pointing gesture in the first sensor data and second sensor data;
determine a target pixel based on the first sensor data, second sensor data, and the pointing gesture; and
determine an object represented at the target pixel.

16. The non-transitory computer readable medium of claim 15, wherein the first sensor data comprises first image data, wherein the second sensor data comprises second image data, and wherein the pointing gesture is detected in an overlap of the first image data and the second image data.

17. A system comprising:
one or more processors; and
one or more computer readable media comprising computer readable code executable by the one or more processors to:
obtain first sensor data from a first device worn on a head;
obtain second sensor data from a second device worn on the head, wherein the first sensor data and the second sensor data correspond to a first time;
determine a head position for the head based on the first sensor data and the second sensor data; and
in response to receiving a selection input, identify an object in a local environment based on the head position and the selection input.

18. The system of claim 17, wherein the one or more processors and the one or more computer readable media are comprised in a mobile device communicably coupled to an audio headset comprising the first device and the second device.

19. The system of claim 17, wherein the first sensor data comprises first orientation data, and wherein the second sensor data comprises second orientation data.

20. The system of claim 17, wherein the first sensor data comprises first image data, wherein the second sensor data comprises second image data, and wherein determining the head position comprises determining a direction of the head based on an overlap between the first image data and the second image data.
